(19) United States
(12) Patent Application Publication
(10) Pub. No.: US 2019/0112216 A1
(43) Pub. Date: Apr. 18, 2019

(54) FABRICATION APPARATUS AND FABRICATION METHOD FOR POROUS GLASS BASE MATERIAL

(71) Applicant: Shin-Etsu Chemical Co., Ltd., Tokyo (JP)

(72) Inventor: Tetsuya OTOSAKA, Gunma (JP)

(21) Appl. No.: 16/134,981

(22) Filed: Sep. 19, 2018

(30) Foreign Application Priority Data
Oct. 13, 2017 (JP) 2017-199689

(51) Int. Cl. C03B 37/014

(52) U.S. Cl. CPC C03B 37/0142; C03B 37/01493; C03B 2207/42; C03B 2207/64; C03B 2207/50

(57) ABSTRACT

A fabrication apparatus for fabricating a porous glass base material for optical fiber includes a core forming burner configured to form a core-corresponding portion corresponding to a core of optical fiber by depositing glass fine particles onto a hanging seed rod, a first clad forming burner configured to form a portion of a clad-corresponding portion corresponding to a clad of the optical fiber by depositing glass fine particles onto the core-corresponding portion, and a second clad forming burner configured to form a different portion of the clad-corresponding portion by depositing glass fine particles to form an outermost surface of the clad-corresponding portion. Here, a central axis of a flame ejected from the second clad forming burner has such a gradient that the central axis of the flame ejected from the second clad forming burner faces upward relative to a horizontal plane.

The contents of the following Japanese patent application are incorporated herein by reference:
NO. 2017-199689 filed on Oct. 13, 2017.

### BACKGROUND

### 1. Technical Field

The present invention relates to a fabrication apparatus and a fabrication method for a porous glass base material.

### 2. Related Art

The Vapor-phase Axial Deposition (VAD) method uses a plurality of synthesizing burners in order to concurrently form a core-corresponding portion and a clad-corresponding portion of a porous glass base material for optical fiber (see Patent Document 1). Patent document 1: Japanese Patent No. 5697165

When a porous glass base material is fabricated according to the method disclosed in Patent Document 1 cited above, the yield may be reduced since the porous glass base material, which is formed by burners arranged horizontally, may partially crack or the like.

### SUMMARY

A first aspect of the present invention provides a fabrication apparatus for fabricating a porous glass base material for optical fiber. The fabrication apparatus includes a core forming burner configured to form a core-corresponding portion corresponding to a core of optical fiber by depositing glass fine particles onto a hanging seed rod, a first clad forming burner configured to form a portion of a clad-corresponding portion corresponding to a clad of the optical fiber by depositing glass fine particles onto the core-corresponding portion, and a second clad forming burner configured to form a different portion of the clad-corresponding portion by depositing glass fine particles to form an outermost surface of the clad-corresponding portion. Here, a central axis of a flame ejected from the second clad forming burner has such a gradient that the central axis of the flame ejected from the second clad forming burner faces upward relative to a horizontal plane.

A second aspect of the present invention provides a fabrication method for fabricating a porous glass base material for optical fiber. The fabrication method includes forming a core-corresponding portion corresponding to a core of optical fiber by depositing glass fine particles onto a hanging seed rod, forming a portion of a clad-corresponding portion corresponding to a clad of the optical fiber by depositing glass fine particles onto the core-corresponding portion, and forming a different portion of the clad-corresponding portion by depositing glass fine particles to form an outermost surface of the clad-corresponding portion. Here, when a portion of the porous glass base material that has a target outer diameter is formed, a burner used to form the other portion of the clad-corresponding portion is tilted such that a central axis of a flame ejected from the burner faces upward relative to a horizontal plane.

The summary clause does not necessarily describe all necessary features of the embodiments of the present invention. The present invention may also be a sub-combination of the features described above.

### BRIEF DESCRIPTION OF THE DRAWINGS

FIG. 1 schematically shows a fabrication apparatus 10.

FIG. 2 is a graph showing how the gradient 0 of an outer clad forming burner 43 is related to deposit efficiency.

FIG. 3 is a graph showing how the gradient 0 of the outer clad forming burner 43 is related to a yield.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

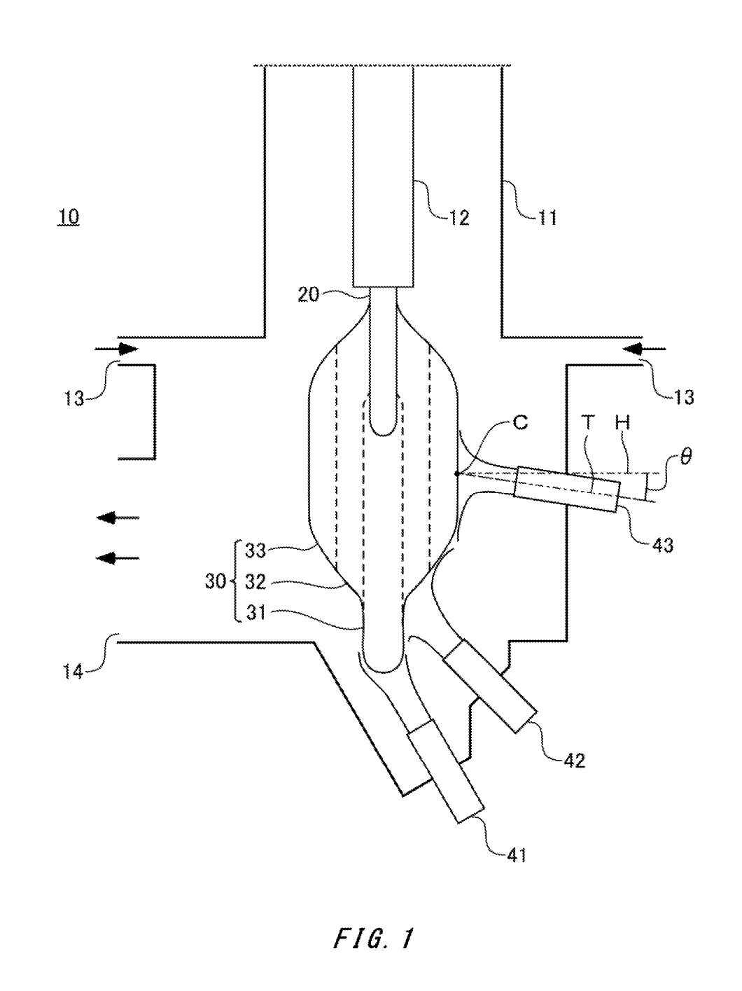

FIG. 1 schematically shows the structure of a fabrication apparatus 10 for fabricating a porous glass base material for optical fiber by means of the VAD method. The fabrication apparatus 10 includes a reaction vessel 11, a holder 12, a core forming burner 41, an inner clad forming burner 42 and an outer clad forming burner 43.

The reaction vessel 11 encloses therein the environment in which a porous glass base material is fabricated, in order to prevent the porous glass base material from being contaminated during the fabricating process and to prevent the glass fine particles and the like that are produced during the fabricating process from scattering. In addition, for the purpose of preparing the atmosphere for the formation of the porous glass base material, the reaction vessel 11 has an inlet 13 and an outlet 14.

Through the inlet 13 of the reaction vessel 11, clean air and the like is fed. In this way, clean environment is maintained for fabricating the porous glass base material. Through the outlet 14 of the reaction vessel 11, part of the fed air and the glass fine particles that have been synthesized but not deposited to form the porous glass base material are passed out of the reaction vessel 11. After passed out of the reaction vessel 11, the glass fine particles are collected outside the reaction vessel 11 and thus prevented from scattering into the surrounding environment.

The holder 12 holds the upper end of a seed rod 20 to hang the seed rod 20 inside the reaction vessel 11. In addition, while keeping the seed rod 20 hanging, the holder 12 rotates around the vertical rotation axis and moves up and down together with the seed rod 20. This makes it possible to hang the seed rod 20, which serves as the target on which the glass fine particles are to be deposited, inside the reaction vessel 11 and to pull up the seed rod 20 as a porous glass base material grows thereon, so that a porous glass base material having a target length can be formed.

The core forming burner 41, the inner clad forming burner 42, and the outer clad forming burner 43 each spray, into a flame such as an oxyhydrogen flame, gases such as silicon tetrachloride and octamethylcyclotetrasiloxane, which are used as the glass source materials, in order to synthesize glass fine particles. The synthesized glass fine particles are deposited around the seed rod 20 hung by the holder 12 to be formed into the porous glass base material 30. The formed porous glass base material 30 is dehydrated and made transparent in a heating furnace in subsequent steps, to be formed into a glass base material.

Here, the porous glass base material 30 includes a core-corresponding portion 31 that is to be formed into the core portion of optical fiber. The core-corresponding portion 31 is formed by the core forming burner 41, which is designed to directly deposit the glass fine particles onto the free end of the seed rod 20. The core forming burner 41 receives the delivery of a source material gas containing germanium tetrachloride as the source material of germanium oxide, which serves as the dopants to raise the refractive index. Furthermore, the core forming burner 41 receives the delivery of silicon tetrachloride serving as the glass source material, a hydrogen gas serving as the combustible gas, an oxygen gas serving as the combustion-supporting gas, a nitrogen gas and an argon gas serving as a seal gas, and the like.

The porous glass base material 30 also includes an inner-clad-corresponding portion 32 and an outer-clad-corresponding portion 33, which are to be formed in to the clad portion of the optical fiber. Since the clad-corresponding portions have in total a significantly larger volume than the core-corresponding portion, the clad -corresponding portions may be formed using a plurality of synthesizing burners. The shown example provides an inner clad forming burner 42 for forming the inner-clad-corresponding portion 32, which is in the clad-corresponding portion and adjacent to the core-corresponding portion 31, and an outer clad forming burner 43 for forming the outer-clad-corresponding portion 33, which constitutes the surface of the clad-corresponding portion. Here, although the number of clad forming burners is not limited to two, the outer clad forming burner 43 denotes the burner used to form the outermost surface of the outer-clad-corresponding portion 33.

The inner clad forming burner 42 and the outer clad forming burner 43 may receive the delivery of silicon tetrachloride serving as the glass source material, a hydrogen gas serving as the combustible gas, an oxygen gas serving as the combustion-supporting gas, an argon gas serving as a seal gas, and the like, without addition of dopants designed to change the refractive index. Alternatively, for the purpose of adjusting the refractive index of the clad portion, a germanium tetrachloride gas, a silicon tetrafluoride gas and the like may be added.

When the porous glass base material 30 is fabricated using the above-described fabrication apparatus 10, the setting condition of the core forming burner 41 is determined by the target specification of the core-corresponding portion 31 to be formed, and the like. Since the inner-clad-corresponding portion 32 is formed directly on the surface of the core-corresponding portion 31, the setting condition of the inner clad forming burner 42 also largely depends on the setting condition of the core forming burner 41 and the like.

On the other hand, there are no particular limitations on the setting condition of the outer clad forming burner 43. When a plurality of burners are used to form the clad-corresponding portion, however, the flames of the burners may interfere with each other, which may reduce the deposit efficiency of the glass fine particles to form the porous glass base material 30. Here, the deposit efficiency of the glass fine particles denotes the ratio of the glass fine particles that have been deposited to form the porous glass base material 30 to all the glass fine particles produced by the synthesizing burners.

If the deposit efficiency of the glass fine particles drops, the yield per unit of source materials drops and the costs of the source materials rise. In addition, the glass fine particles that have not been deposited to form the porous glass base material 30 may be deposited onto the inner surface of the reaction vessel 11 to cause agglomerated soot. Such glass fine particles are impurities for the growing porous glass base material 30 and may thus result in lower quality, for example, foams in the glass base material.

When a plurality of synthesizing burners are used to form the clad-corresponding portion, the porous glass base material 30 being fabricated may have a heat distribution. Due to its fragility, the porous glass base material 30 may suffer from cracks or peeling if thermal stress is created during or immediately after the fabrication. This may lower the yield of the porous glass base material 30.

It is presumed that, while the porous glass base material 30 is being formed, the flame of the inner clad forming burner 42 and the flame of the outer clad forming burner 43 may interfere with each other if the flames of these two burners excessively approach each other. It is also presumed that, if the flame of the inner clad forming burner 42 and the flame of the outer clad forming burner 43 are positioned excessively distant from each other, a temperature distribution is created in the surface of the porous glass base material 30 and thermal stress is created in the porous glass base material 30. Based on these presumptions, the gradient 0 formed by the center line T of the outer clad forming burner 43 relative to the horizontal plane H was varied to change the position at which the flame of the outer clad forming burner 43 was applied to the surface of the porous glass base material 30. In this way, it was investigated how the gradient 0 affected the quality of the porous glass base material 30 to be formed.

The gradient 0 of the outer clad forming burner 43 was varied by rotating the outer clad forming burner 43 around the point C at which the surface of the porous glass base material 30 that had a target outer diameter intersected with the central axis of the outer clad forming burner 43 that was positioned horizontally. The gradient 0 of the outer clad forming burner 43 was defined to have a positive value when the mouth of the burner from which the flame was ejected was positioned above relative to the main body of the burner so that the outer clad forming burner 43 faced upward relative to the horizontal plane H.

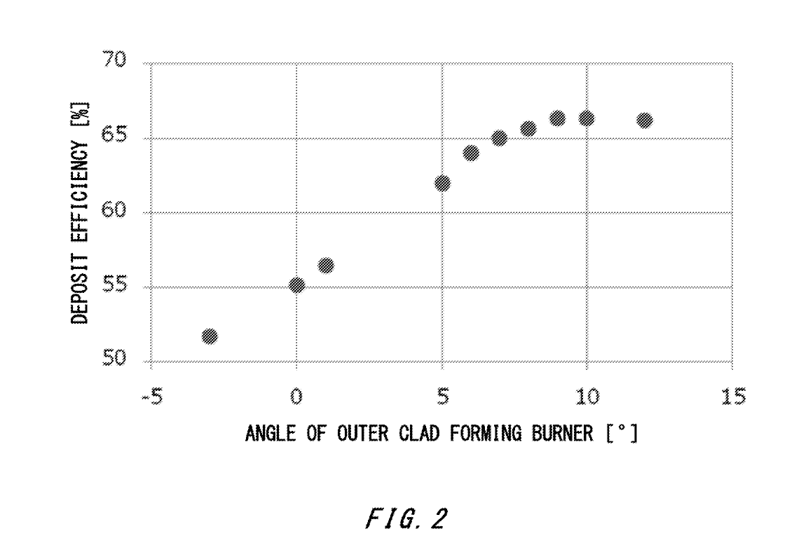

A plurality of porous glass base materials 30 were fabricated with varying angles of the outer clad forming burner 43, and the deposit efficiency [%] of the glass fine particles was measured for each of the fabricated porous glass base materials 30. The measurements are shown in Table 1. FIG. 2 shows a graph plotting the measurements shown in Table 1.

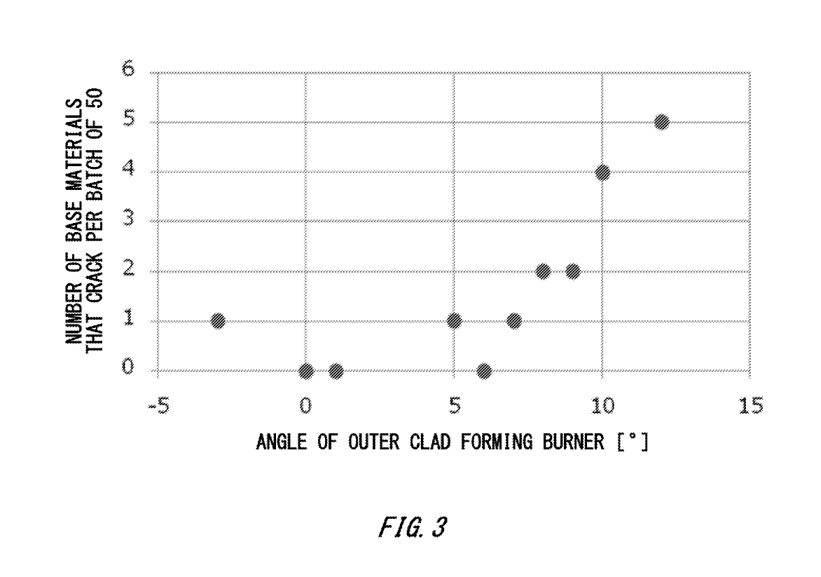

Furthermore, for each value of the gradient 0 of the outer clad forming burner 43, it was measured how many of the porous glass base materials 30 crack per batch of 50 porous glass base materials. The measurements are also shown in Table 1 and plotted in the graph shown in FIG. 3.

TABLE 1

| ANGLE OF | DEPOSIT | NUMBER OF BASE |
|---|---|---|
| OUTER CLAD | EFFICIENCY | MATERIALS THAT CRACK |
| FORMING BURNER [°] | [%] | PER BATCH OF 50 |
| −3 | 51.7 | 1 |
| 0 | 55.2 | 0 |
| 1 | 56.5 | 0 |
| 5 | 62 | 1 |
| 6 | 64 | 0 |
| 7 | 65 | 1 |
| 8 | 65.6 | 2 |
| 9 | 66.3 | 2 |
| 10 | 66.3 | 4 |
| 12 | 66.2 | 5 |

As shown in Table 1 and FIG. 2, as the gradient 0 of the outer clad forming burner 43 increases, the deposit efficiency rises while the gradient 0 falls in the range of 1° to 9°. However, once the gradient 0 of the outer clad forming burner 43 exceeds 9°, the deposit efficiency of the glass fine particles drops. Accordingly, from the perspective of the deposit efficiency of the glass fine particles, the gradient 0 of the outer clad forming burner 43 preferably falls within the range of no less than 1° and no more than 9°.

Also, as can be seen from Table 1 and FIG. 2, when the gradient 0 of the outer clad forming burner 43 reaches 5°, the deposit efficiency of the glass fine particles significantly rises. Accordingly, it is more preferable that the gradient 0 of the outer clad forming burner 43 is no less than 5° within the above-mentioned range.

Furthermore, with reference to Table 1 and FIG. 3, the number of porous glass base materials 30 that crack tends to gradually increase once the gradient 0 of the outer clad forming burner 43 exceeds 7°. Accordingly, it is more preferable that the gradient 0 of the outer clad forming burner 43 is no more than 7° within the above-mentioned range.

As described above, when a plurality of clad forming burners are used in conjunction with the VAD method, the quality and yield of the porous glass base material 30 can be improved by appropriately setting the angle of the outer clad forming burner 43, which is designed to form the surface of the clad-corresponding portion. More specifically, by controlling the gradient 0 of the outer clad forming burner 43 to fall within the range of no less than 1° and no more than 9°, more preferably within the range of no less than 5° and no more than 7° so that the burner can face upward relative to the horizontal plane, the deposit efficiency of the glass fine particles can be improved and the occurrence of the crack in the porous glass base material 30 can be reduced.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. A fabrication apparatus for fabricating a porous glass base material for optical fiber, comprising:
a core forming burner configured to form a core-corresponding portion corresponding to a core of optical fiber by depositing glass fine particles onto a hanging seed rod;
a first clad forming burner configured to form a portion of a clad-corresponding portion corresponding to a clad of the optical fiber by depositing glass fine particles onto the core-corresponding portion; and
a second clad forming burner configured to form a different portion of the clad-corresponding portion by depositing glass fine particles to form an outermost surface of the clad-corresponding portion, wherein
a central axis of a flame ejected from the second clad forming burner has such a gradient that the central axis of the flame ejected from the second clad forming burner faces upward relative to a horizontal plane.

2. The fabrication apparatus as set forth in claim 1, wherein the second clad forming burner has an angle of no less than 1° and no more than 9° relative to the horizontal plane.

3. The fabrication apparatus as set forth in claim 1, wherein the second clad forming burner has an angle of no less than 5° and no more than 7° relative to the horizontal plane.

4. A fabrication method for fabricating a porous glass base material for optical fiber, comprising:
forming a core-corresponding portion corresponding to a core of optical fiber by depositing glass fine particles onto a hanging seed rod;
forming a portion of a clad-corresponding portion corresponding to a clad of the optical fiber by depositing glass fine particles onto the core-corresponding portion; and
forming a different portion of the clad-corresponding portion by depositing glass fine particles to form an outermost surface of the clad-corresponding portion, wherein
when a portion of the porous glass base material that has a target outer diameter is formed, a burner used to form the different portion of the clad-corresponding portion is tilted such that a central axis of a flame ejected from the burner faces upward relative to a horizontal plane.
